(19) United States
(12) Patent Application Publication
(10) Pub. No.: US 2004/0029530 A1
(43) Pub. Date: Feb. 12, 2004

(54) Waterproof electroacoustic transducer and portable electronic device provided with the same

(76) Inventors: Koichi Noguchi, Chiba-shi (JP); Yasuo Maekawa, Nishitama-gun (JP)

Correspondence Address: ADAMS & WILKS, 31st Floor, 50 Broadway, New York, NY, 10004, US

(21) Appl. No.: 10/354,572

(22) Filed: Jan. 30, 2003

(30) Foreign Application Priority Data
Feb. 13, 2002 (JP) 2002-035342

(51) Int. Cl. H04B 7/165

(52) U.S. Cl. 455/23

(57) ABSTRACT

To provide a waterproof electroacoustic transducer having a high waterproof performance and a portable electronic device provided with the same. The waterproof electroacoustic transducer of the portable electronic device includes: an electroacoustic transducer main body provided with an electroacoustic transducing element on a front surface thereof; a frame body forming a recessed section with the electroacoustic transducing element of the electroacoustic transducer main body as a bottom wall thereof; and a waterproof sheet with flexibility that is fixed to the frame body in a peripheral part thereof so as to close a front opening of the recessed section in order to turn the recessed section into a substantially closed air chamber and follows acoustic vibration of the air inside and outside the air chamber, in which the waterproof sheet is provided with irregularities projected or recessed forward or rearward with respect to an average extending surface S thereof in a state in which no external force is applied to the waterproof sheet such that the waterproof sheet can bend along a wall part of the recessed section while substantially maintaining a length along an extending direction of the waterproof sheet under pressurization.

### BACKGROUND OF THE INVENTION

1. Field of the Invention

The present invention relates to a waterproof electroacoustic transducer, and in particular, to a compact waterproof electroacoustic transducer suitable for being used in a portable electronic device such as a cellular phone.

In this specification, an electroacoustic transducer typically means a transducer for transducing a mechanical vibration (sound) into an electric signal such as a microphone. However, it also includes a transducer (typically a speaker) for transducing an electric signal into a mechanical vibration (sound).

2. Description of the Related Art

It has been proposed that, in a mobile communication device such as a so-called cellular phone, a waterproof microphone is formed by disposing a microphone main body such that a sound receiving surface is opposed to a sound communication hole in a housing provided with the sound communication hole and, at the same time, arranging a flat disk-like cover made of a non-porous very thin resin film with water resistance between the sound communication hole and the sound receiving surface, and sandwiching and supporting a peripheral part of the cover from its both sides with spacers such as rubber rings to fix and seal the cover (for example, JP 10-210121 A). In the microphone proposed in this publication, the disk-like cover is vibrated by acoustic vibration, which has entered from the sound communication hole, and the air in an air chamber between the cover and the sound receiving surface of the microphone main body is vibrated by film vibration of the cover to transmit the acoustic vibration to the sound receiving surface of the microphone main body.

However, in the case of the waterproof microphone proposed in this specification, when the mobile communication device provided with the microphone is exposed to a heavy rain or the mobile communication device is dropped in the water by mistake, it is likely that water enters the air chamber due to insufficient waterproof. On the other hand, if a waterproof performance in the sealed part is high, it is likely that a film itself of the very thin resin film constituting the cover is extended by a water pressure or broken by excessive extension and a desired acoustic vibration transmitting characteristic is lost. In any case, it is likely that the conventional microphone provided with the waterproof cover made of a disk-like resin film lacks a waterproof performance.

Note that, although there is also known a waterproof cover using a porous film consisting of repellent resin such as fluorocarbon resin, such a porous film also has an insufficient waterproof performance because it is difficult to avoid permeation of water under pressurization.

### SUMMARY OF THE INVENTION

The present invention has been devised in view of the above-mentioned drawbacks, and it is an object of the present invention to provide a waterproof electroacoustic transducer having a high waterproof performance and a portable electronic device provided with the same.

In order to attain the aforementioned object, the waterproof electroacoustic transducer of the present invention is a waterproof electroacoustic transducer including: an electroacoustic transducer main body provided with an electroacoustic transducing element on a front surface thereof; a frame body forming a recessed section with the electroacoustic transducing element of the electroacoustic transducer main body as a bottom wall thereof; and a waterproof sheet with flexibility that is fixed to the frame body in a peripheral part thereof so as to close a front opening of the recessed section in order to turn the recessed section into a substantially closed air chamber and substantially follows acoustic vibration of the air inside and outside the air chamber, in which the waterproof sheet is provided with irregularities projected or recessed forward or rearward with respect to an average extending direction thereof in a state in which no external force is applied to the waterproof sheet such that the waterproof sheet can bend along a wall part of the recessed section while substantially maintaining a length along an extending direction of the waterproof sheet under pressurization.

In the waterproof electroacoustic transducer of the present invention, the electroacoustic transducing element of the electroacoustic transducer main body faces the air chamber by forming the bottom wall of the recessed section constituting the air chamber. Thus, vibration or a compressional wave (sound) of the air in the air chamber can be transmitted to the electroacoustic transducing element (in the case of a microphone) or vibration of the electroacoustic transducing element can be transmitted to the air in the air chamber as a compressional wave (sound) (in the case of a speaker). Acoustic vibration transmitted between the air in the air chamber and the electroacoustic transducing element is transmitted from the outside to the air chamber or from the air chamber to the outside via the waterproof sheet with flexibility that follows vibration of the air inside and outside the air chamber (i.e., inside and outside the waterproof sheet).

In the waterproof electroacoustic transducer of the present invention, the waterproof sheet, which forms the substantially closed air chamber-by closing the front opening of the recessed section formed by the electroacoustic transducer main body and the frame body so as to have the transducing element of the transducer main body as the bottom wall, is arranged to be fixed to the frame body in the peripheral part thereof. Thus, since water is prevented from entering the electroacoustic transducer main body by the waterproof sheet, the waterproof performance can be maintained.

In addition, in the waterproof electroacoustic transducer of the present invention, in particular, the waterproof sheet is provided with the projected section that is curved forward convexly with respect to the average extending direction of the waterproof sheet in a state in which no external force is applied to it. Thus, even in the case in which the electroacoustic transducer is exposed to a heavy rain or the like or is dropped in water by mistake and a relatively large water pressure is applied to the waterproof sheet, the waterproof sheet can be spread such that the projections almost disappear and can be bent toward the inside of the recessed section while substantially keeping the length along the extending direction thereof. That is, under pressurization, the projected section of the film constituting the waterproof sheet is spread and the film bends toward the inside of the recessed section formed by the frame body and the transducer main body, whereby a volume of the air chamber can be reduced to increase a pressure in the substantially closed air chamber. As a result, since pressures applied to the inside and the outside of the waterproof sheet substantially balance, the film itself of the waterproof sheet is not required to support a large pressure difference. Note that a certain degree of pressure difference can be supported by the projected section of the waterproof sheet spreading. Therefore, even if a relatively large pressure is applied to the waterproof sheet, the waterproof sheet is hardly subjected to such s large tension as to extend the film itself (enlarge the area of the film itself). Thus, it is unlikely that tensile deformation exceeding an elastic limit occurs, and the likelihood of extension of the film itself of the waterproof sheet can be controlled to the minimum. As a result, when the water pressure is not applied to the waterproof sheet any more, the waterproof sheet can return to the state in which the waterproof sheet has the projected section curved forward convexly with respect to the average extending direction of the waterproof sheet. That is, even if a relatively high pressure is applied to the waterproof sheet, since the characteristic of the waterproof sheet relating to transmission of acoustic vibration does not change practically in the state in which the pressure is released, it is less likely that the acoustic characteristic of the electroacoustic transducer varies.

In the above description, the air chamber preferably has a large volume sufficient to allow a change in the volume (in other words, a change in pressure) to be neglected depending on vibration of the waterproof sheet involved in ordinary transmission of acoustic vibration.

Note that, in the above description, the waterproof sheet may be provided with a recessed section that is curved forward concavely (backward convexly) in addition to the projected section curved forward convexly.

In addition, in the above description, under a relatively large pressure, the projected section of the waterproof sheet not only bends toward the inside of the recessed section but also may rest against the wall part of the recessed section to be supported by the wall part. In this case, since an area of the film part of the waterproof sheet, which should support a water pressure or the like, can be reduced, the likelihood of extension of the film itself of the waterproof sheet can be further reduced.

From this point of view, preferably, the waterproof sheet can be not only provided with the projected section curved forward convexly but also provided with the recessed section recessed backward (i.e., curved forward concavely) relatively to the projected section. That is, preferably, the waterproof sheet is provided with irregularities, which are projected or recessed forward or rearward with respect to the average extending direction of the waterproof sheet, in the state in which no external force is applied to it such that the waterproof sheet can bend along the wall part of the recessed section while substantially maintaining the length along the extending direction of the sheet under pressurization. In this case, corner parts of sidewalls and the bottom wall may have roundness such that the waterproof sheet can bend along the sidewalls and the bottom wall without being deformed excessively.

In the waterproof electroacoustic transducer of the present invention, in the case in which the waterproof sheet is provided with the irregularities, which are projected or recessed forward or rearward with respect to the average extending direction of the waterproof sheet, in the state in which no external force is applied to it, even if a relatively large water pressure is applied to the waterproof sheet, the irregularities are spread largely. Thus, since a relatively large part of the film constituting the waterproof sheet can easily rest against a recessed section formed surface of the frame body and a recessed section formed surface of the electroacoustic transducer main body and is supported by the recessed section formed surfaces of the frame body and the electroacoustic transducer main body according to the resting, the likelihood of extension of the film itself constituting the waterproof sheet can be controlled to the minimum. Therefore, it is less likely that tensile deformation exceeding the elastic limit occurs in the waterproof sheet, and the likelihood of extension of the film itself of the waterproof sheet can be controlled to the minimum.

In the above description, the average extending direction of the waterproof sheet indicates an extending surface of the waterproof sheet in which the projected section and the irregularities of the waterproof sheet are practically neglected. This extending surface is typically a plane. However, this average extending surface itself may be a projected surface or a recessed surface. In addition, concerning “extension” of the waterproof sheet, the extending direction of the waterproof sheet indicates a direction along the film of the waterproof sheet. In the projected section or the recessed section of the waterproof sheet, it indicates a direction along the slope of the film surface part forming the projected section. Moreover, in this specification, concerning the projected section and the recessed section or the irregularities of the waterproof sheet, “projected” means curved forward convexly and “recessed” means curved forward concavely, that is, curved backward convexly unless specifically provided otherwise. In addition, concerning the waterproof sheet, “front” means a side that is not opposed to the air chamber of the waterproof sheet, and “rear” means a side opposed to the air chamber of the waterproof sheet unless specifically provided otherwise. Further, concerning “front and rear” indicates the same direction for other parts of the transducer unless specifically provided otherwise.

As described above, the electroacoustic transducer may be one for transducing sound (an acoustic signal) into an electric signal (typically, a microphone) or one for transducing an electric signal into sound (an acoustic signal) (typically, a speaker). In order to avoid complexity and redundancy of explaining transmission directions of signals and vibration, descriptions will be hereinafter made assuming that the electroacoustic transducer is a microphone.

In the electroacoustic transducer of the present invention (that is, e.g., microphone), the waterproof sheet, on the one hand, is provided with a vibration transmitting function for transmitting sound in the form of a compressional wave of the air to the air in the air chamber without attenuating the sound. In the transmission of air vibration, a frequency characteristic of vibration of the waterproof sheet is preferably flat as much as possible within a desired range, and the waterproof sheet is preferably provided with such flexibility as to make a resistance against air vibration minimum. However, the waterproof sheet preferably has elasticity for returning to its original shape with respect to deformation involved in this air vibration. Consistency of such flexibility and elasticity is realized by the waterproof sheet being provided with the projected section curved at least forward convexly with respect to the average extending surface of the waterproof sheet, and preferably being provided with the irregularities, which are projected or recessed forward or rearward. That is, since the flexibility of the waterproof sheet is increased by the waterproof sheet being provided with the projected section (preferably, irregularities), it becomes possible to make a film thickness of the waterproof sheet relatively large, and it becomes easy to make flexibility and elasticity consistent with each other. That is, vibration of the waterproof sheet provided with this projected section (preferably, irregularities) is not film vibration with which the waterproof sheet itself is extended along the sheet extending surface but is rather caused by a film part in the vicinity of the projected section (preferably, irregularities) of the waterproof sheet bending (a degree of bending changing) such that a degree of projection (preferably, irregularities) varies. Thus, the waterproof sheet not only can be easily vibrated by a small stress but also can be returned to its original state easily.

Concerning the irregularities of the waterproof sheet, respective edges of the irregularities typically extend in the form of a closed curve along the peripheral wall of the recessed section. Here, “along the peripheral wall” means that a distance from the peripheral wall is substantially uniform. If a geometry of the peripheral wall (a form of the peripheral wall viewed from its front side) is circular, the respective edges of the irregularities typically form a circle concentric with a circle of the peripheral wall as a closed curve. If the geometry of the peripheral wall is elliptical, the respective edges of the irregularities forms an ellipse, which has a major axis and a minor axis in directions identical with those of the ellipse of the peripheral wall and has substantially the same eccentricity as the ellipse of the peripheral wall, as a closed curve. Consequently, substantially the same degree of tension is applied to each part of the waterproof sheet. However, the shape of the edges may not be elliptical so strictly. In particular, for example, regardless of the geometry of the peripheral wall, the shape may be closer to a circle as the edges are apart from the peripheral wall by a greater distance.

In addition, in the waterproof electroacoustic transducer of the present invention, the waterproof sheet is typically provided with a projected section in a closed curve shape in the vicinity of a fixed peripheral part thereof as the irregularities. Consequently, substantially the entire surface of the waterproof sheet can be displaced largely under a pressure. That is, in the case in which a relatively large pressure is applied to the waterproof sheet, since the projected section extending in a closed curve shape in the vicinity of the peripheral part is spread, the waterproof sheet can bend along a surface of the peripheral wall, that is, a peripheral surface, and reduce the volume of the air chamber. Thus, it is less likely that an excessive tension is applied to the waterproof sheet.

In addition, in the waterproof electroacoustic transducer of the present invention, the waterproof sheet is typically provided with a dome-like section, which is projected forward, in its central part as the irregularities. Consequently, in the case in which a relatively large pressure is applied to the waterproof sheet, since the central part of the waterproof sheet can contact the bottom of the recessed section easily, it is less likely that an excessive tension is applied to the waterproof sheet. Further, in the case in which a relatively sharp pressure variation is applied to the waterproof sheet, in order to facilitate spread of the variation to the front surface of the waterproof sheet, it is preferable that the central part is projected forward. However, if desired, a projected section of a closed curve shape surrounding the central part may be provided in the vicinity of the central part instead of the dome-like section, which is projected forward, in the central part.

Note that, in the case in which the waterproof sheet is provided with a plurality of projected sections forming a closed curve, even if the bottom of the recessed section formed by the frame body and the transducer main body is formed in a plurality of steps, when the projected section of the waterproof sheet is spread, the waterproof sheet can abut against a surface of each step of the recessed section of the frame body and the transducer main body to be supported. Such a recessed section with a plurality of steps is formed in such a case in which, for example, a bottom of a deep recessed section in the center consists of the front surface of the electroacoustic transducing element of the electroacoustic transducer main body and a bottom of a shallower recessed section in the periphery consists of the frame body part supporting the waterproof sheet and the electroacoustic transducer main body. However, if desired, the bottom of the recessed section may be formed in more steps. Note that the bottom of the recessed section may be provided with a single flat surface instead of the bottom of a plurality of steps.

Concerning the irregularities of the waterproof sheet, the projected section and the recessed section are relative to each other. In the case in which there are a plurality of projected sections of a closed curve shape, a recessed section of a closed curve shape is relatively formed between the adjacent projected sections of a closed curve shape. In the case in which there are a plurality of recessed sections of a closed curve shape in the waterproof sheet, a projected section of a closed curve shape is relatively formed between the adjacent recessed sections of a closed curve shape.

A material forming the waterproof sheet typically consists of resin. As the resin, one with a high mechanical strength such as polyethylene terephthalate (PET) resin or polyimide resin is typically used. However, if desired, other kinds of resin may be used. Alternatively, the material forming the waterproof sheet may consist of other flexible film-forming materials instead of resin.

A thickness of the waterproof sheet may vary depending on a type of a sheet-forming material, an area of an opening of the recessed section of the frame body that should be covered by the waterproof sheet, a size of the irregularities, and the like. In the case in which the waterproof sheet consists of polyethylene terephthalate (PET) resin or polyimide resin, the waterproof sheet typically has a thickness between approximately 10 μm to 30 μm. However, if desired, the waterproof sheet may be thinner than approximately 10 μm or may be thicker than approximately 30 μm.

In the waterproof electroacoustic transducer of the present invention, the frame body is typically provided with a central opening section communicating with the electroacoustic transducing element of the electroacoustic transducer main body and a ring-like recessed section of a larger diameter placed on the front surface of the central opening section, and supports the peripheral part of the waterproof sheet in the peripheral wall of the recessed section. In this case, as described above, the bottom wall of the recessed section consists of a plurality of steps (typically, two steps).

In the waterproof electroacoustic transducer of the present invention, a porous metal plate is typically arranged on the front surface of the electroacoustic transducing element of the electroacoustic transducer main body.

In addition, in order to attain the aforementioned object, the portable electronic device with the waterproof electroacoustic transducer of the present invention is a portable electronic device with a waterproof electroacoustic transducer that has a cover side housing section provided with a sound communication hole opened in the front surface of a waterproof sheet in addition to the waterproof electroacoustic transducer as described above, in which a part between the inside of the cover side housing section and the surface of the waterproof sheet is sealed water-tightly in a peripheral section of the waterproof sheet. Even if rainwater or the like enters from the sound communication hole, it is possible to prevent the rainwater from invading the periphery of the waterproof sheet by this seal. Note that it is possible to prevent the front surface of the waterproof sheet from being exposed to rainwater or being soiled by dusts or the like as much as possible by providing the cover side housing section having the sound communication hole. For these purposes, the sound communication hole is preferably as small as possible. However, it may be a larger to some extent.

In the portable electronic device with the waterproof electroacoustic transducer of the present invention, typically, a base side housing section provided with a transducer receiving recessed section for receiving the electroacoustic transducer is further included, and a part between the front surface of a peripheral wall of the transducer receiving recessed section of the base side housing section and the inside of the cover side housing section is sealed water-tightly. It is possible to prevent rainwater or the like from reaching the outer periphery of the waterproof sheet from the side of the housing by this seal.

By forming the seals in two places as described above, it is possible to practically prevent water from entering the electroacoustic transducer main body surely.

### BRIEF DESCRIPTION OF THE DRAWINGS

In the accompanying drawings:

FIG. 1 is an explanatory sectional view of an arm-wear-type cellular phone provided with a microphone as an electroacoustic transducer of a preferred embodiment according to the present invention;

FIG. 2 is an explanatory enlarged sectional view of the microphone used in the cellular phone of FIG. 1; and

FIG. 3 a partially cutout explanatory enlarged perspective view of a waterproof sheet used in the microphone of FIG. 2.

### DETAILED DESCRIPTION OF THE PREFERRED EMBODIMENTS

A preferred embodiment mode of the present invention will be described based on preferred embodiments shown in the accompanying drawings.

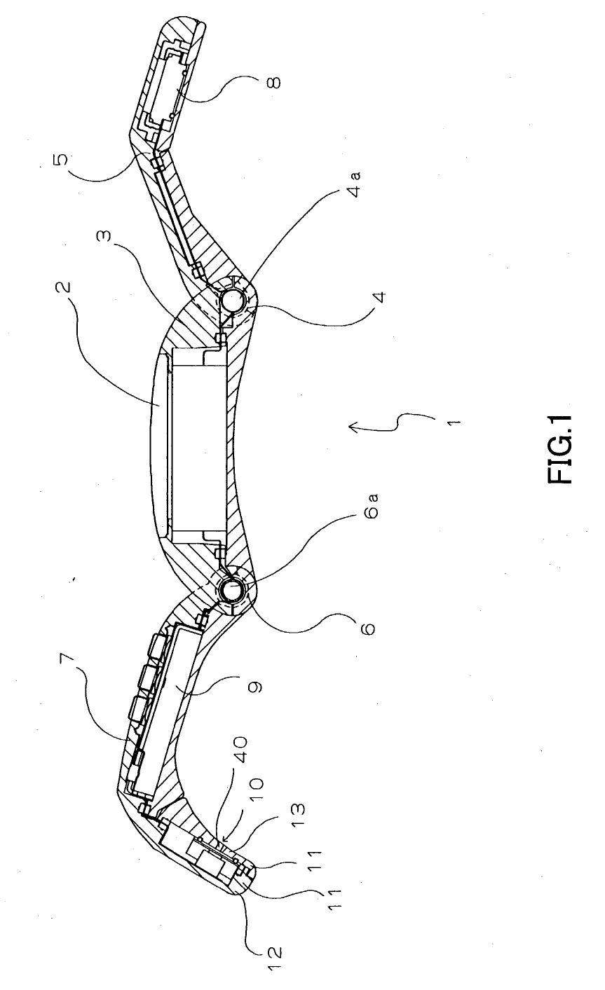

FIGS. 1 to 3 show an arm-wear-type cellular phone 1 as a portable electronic device provided with a microphone 10 as an electroacoustic transducer of a preferred embodiment of the present invention.

The arm-wear-type cellular phone 1 is wearable around an arm (typically, a wrist) and, as it is seen from FIG. 1 showing a state in which the arm-wear-type cellular phone 1 is removed from the arm, it is provided with a body section 3 including a display unit 2, one band section or arm-mounting section 5 coupled to the body section 3 in one hinge section 4, and the other band section or arm-mounting section 7 coupled to the body section 3 in the other hinge section 6. The two band sections or arm-mounting sections 5 and 7 typically have a rigid housing structure, respectively, and can pivot around pivotal shafts 4a and 6a of the hinge sections 4 and 6, respectively, between an opened position shown in FIG. 1 and a closed position in which the arm-wear-type cellular phone 1 is worn around the arm. The rigid band section 5 also serves as a receiver including a speaker 8, and a transmitter including a microphone 10 is formed in the rigid band section 7 in addition to a telephone main body 9. An electronic watch main body is incorporated in the inner part of the display unit 2 of the body section 3, and the display unit 2 usually performs, for example, so-called hand-type time display. In the case of this example, for example, the band section 5 is placed on the twelve o'clock side of the electronic watch and the band section 7 is placed on the six o'clock side of the electronic watch. However, the twelve o'clock side and the six o'clock side may be reversed. In addition, the electronic watch consisting of the electronic watch main body and the display unit 2 may be one that performs so-called digital-type number display. It goes without saying that, utilizing a microprocessor incorporated in the telephone main body 9, the electronic watch may display other arbitrary information on the display unit 2 or may function as a personal digital assistant. Note that, in this example, for example, the display unit 2 is controlled by a display control unit, which is under the control of the microprocessor of the telephone main body 9, so as to display a telephone number and other information of a transmitter or a receiver of telephone call instead of time information, or simultaneously with the time information, as in a conventional mobile telephone.

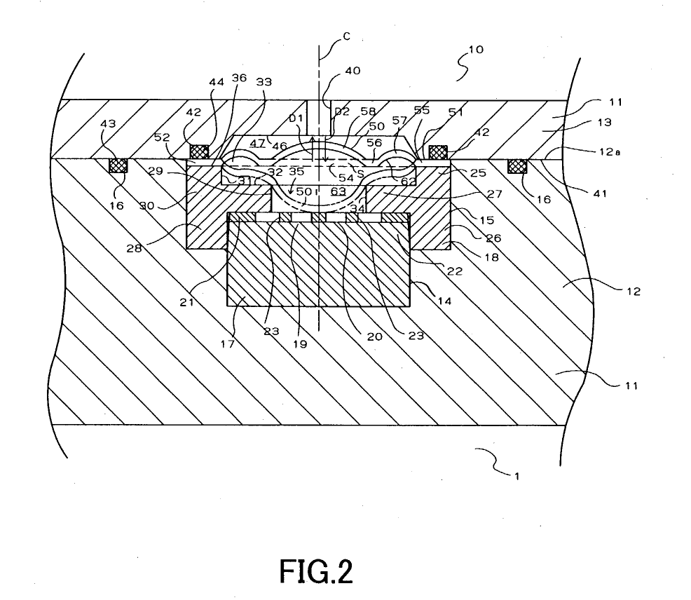

As shown with an enlarged sectional view in FIG. 2, the microphone 10 is contained in a housing 11 between a base side housing section 12 and a cover side housing section 13 forming the housing 11 of the rigid band section 7. Note that, in FIG. 2, the microphone 10 is enlarged particularly in its thickness direction (vertical direction in FIG. 2) exaggeratedly such that a shape or a recessed section of a waterproof sheet can be seen easily. In addition, in the following description, although sizes are indicated by numerical values, these are preferred examples only and the present invention is not limited by these numerical values.

More specifically, a cylindrical or columnar microphone main body containing recessed section 14, a cylindrical or columnar ring-shaped frame body containing recessed section 15, and an annular packing containing recessed section 16 are formed in the base side housing section 12 with an axial line C as a central axial line. A microphone main body 17 is fit in the recessed section 14 and a ring unit or ring-like frame body 18 as a frame body is fit in the recessed section 15. On a front surface 20 of the microphone main body 17 where an electroacoustic transducing element 19 for transducing an acoustic signal in the form of mechanical vibration to an electric signal is placed, a cover 21 consisting of a porous thin plate of metal is arranged. In a front side section 22 of the microphone main body 17 where the cover 21 is mounted, the ring-like frame body 18 is fitted.

The electroacoustic transducing element 19 of the microphone main body 17 consists of, for example, an electret, a piezoelectric element, or the like. Although not shown in FIG. 2, the electroacoustic transducing element 19 is incorporated in the microphone main body 17 such that it can sense pressure variation responding to vibration of the air or can mechanically vibrate. Note that the electroacoustic transducing element 19 may be any other electroacoustic transducer as long as it can transduce an acoustic signal in the form of air vibration into an electric signal finally.

The cover, that is, the porous thin plate 21 is for protecting the front surface 20 of the microphone main body 17 while allowing a compressional wave or vibration of the air to be transmitted to the front surface 20 of the microphone main body 17, and has a large number of permeable holes 23 for allowing transmission of vibration of the air. In the case in which the porous thin plate 21 has a thickness of approximately 0.1 mm, the holes 23 are, for example, small holes having a diameter of approximately 0.5 mm to 1 mm and a small aspect ratio. However, a diameter, a shape and the number of the holes are not limited as long as the holes can transmit most of vibration energy to the electroacoustic transducing element 19 placed on the front surface 20 of the microphone main body 17 without substantial attenuation or delay while protecting the front surface 20 of the microphone main body 17. The porous thin plate 21 may be thinner as long as it can protect the front surface 20 of the microphone main body 17 with sufficient mechanical strength. In addition, the porous thin plate 21 may be thicker as long as it can transmit most of vibration energy to the electroacoustic transducing element 19 of the microphone main body 17 without substantial attenuation or delay. Further, the porous thin plate 21 may be made of other conductive materials as long as it can satisfy the above-mentioned conditions and, if conductivity is not required, may be made of nonconductive resin or other nonconductive materials such as a ceramic material with low piezoelectricity.

The ring-like frame body 18 consists of front side and base side cylindrical sections 25 and 26, external peripheral surfaces of which form a common cylindrical surface, and a flange-like section 27 of an annular plate shape projected inward radially between these cylindrical sections 25 and 26. A base side ring-like section 28 consisting of the base side cylindrical section 26 and the annular flange-like section 27 is fittingly mounted on the microphone main body 17 and the porous thin plate 21. On the other hand, a front side ring-like frame section 30 consisting of the front side cylindrical section 25 and the annular flange-like section 27 forms a waterproof sheet supporting section provided with an opening 29 as a whole. An inner peripheral surface 31 of the front side cylindrical section 25 and a surface 32 of the flange-like section 27 facing forward cooperate to form a cylindrical or columnar front side recessed section 33 with the axial line C as a center, A peripheral surface 34 of the opening 29 cooperate with a front surface of the microphone main body 17 (more specifically, the front surface of the porous thin plate 21 provided with the more holes 23) to form a cylindrical or columnar base side recessed section 35 that is concentric with the front side recessed section 33. The front side recessed section 33 has, for example, a radius of the peripheral surface 31 of approximately 8 mm and a depth (height) of approximately 0.3 mm. The base side recessed section 35 has, for example, a radius of approximately 4 mm and a depth (height) of approximately 0.3 mm. However, the recessed sections 33 and 35 maybe larger or smaller and the shape of them may be more flat or more oblong as long as they can transmit acoustic vibration to the microphone main body 17 without excessively attenuating the acoustic vibration.

A waterproof sheet 50 is mounted on an annular front end surface 36 of the front side cylindrical section 25 constituting the front side ring-like frame section 30, and the cover side housing section 13 is mounted on this waterproof sheet 50. The cover side housing section 13 has a cylindrical or columnar through-hole for sound communication with the axial line C as a center, that is, a sound communication hole 40 along the axial line C and, at the same time, has an annular groove 42 with the axial line C as a center on an inner surface 41. The sound communication hole 40 is, for example, a hole that has a diameter of approximately 1 mm and a length of approximately 1.5 mm to 2 mm. The sound communication hole 40 may have an expanded diameter or a reduced diameter in its inner side instead of having a cylindrical shape or a columnar shape as long as it can transmit air vibration to the inside without excessive attenuation.

Packings 43 and 44 as seal rings are disposed in the annular recessed section 16 formed in the front surface 12a of the base side housing section 12 and the annular recessed section 42 formed in the inner surface 41 of the cover side housing section 13, respectively. In a state in which the cover side housing section 13 is mounted and fixed on the base side housing section 12, the packings 43 and 44 seal the part between the inner surface 41 of the cover side housing section 13 and the front surface 12a of the base side housing section 12 and, at the same time, seal the part between the inner surface 41 of the cover side housing section 13 and a front surface 51 of the waterproof sheet 50 and holds the waterproof sheet 50 in a peripheral part 52, that is, an external peripheral part 52 of a peripheral annular flat section 55 discussed later.

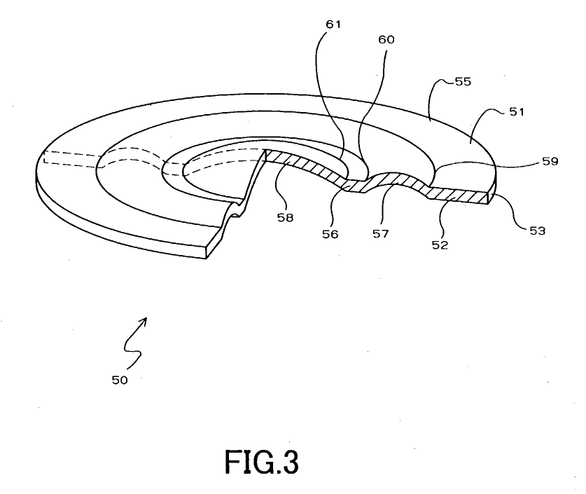

The waterproof sheet 50 consists of, for example, a molded film of PET or polyimide with a thickness of approximately 10 μm to 30 μm. As shown in FIGS. 2 and 3, the waterproof sheet 50 has a circular external peripheral section 53 and a substantially disk-like shape as a whole. However, the external peripheral section 53 may have other shapes such as an ellipse or an oval, and the overall shape of the waterproof sheet 50 adopts other shapes such as an elliptical plate shape or an oval plate shape according to the shape of the external peripheral section 53.

More specifically, the waterproof sheet 50 has irregularities in a crossing direction (longitudinal direction) with respect to an extending surface S of an imaginary disk 54 forming the overall shape of the waterproof sheet 50 (indicated by an imaginary line in FIG. 2). That is, in the illustrated example, in addition to the peripheral annular flat section 55 and an intermediate annular flat section 56, which extend along the imaginary disk surface S, the waterproof sheet 50 has an annular projected section 57 curved forward convexly between the peripheral annular flat section 55 and the intermediate annular flat section 56. Moreover, the waterproof sheet 50 has a central circular projected section 58 that is projected forward convexly in its central part including the central axial line C.

More specifically, a circular inner edge 59 of the peripheral annular flat section 55 is joined to a circular outer edge (59) of the annular projected section 57, a circular inner edge 60 of the annular projected section 57 is joined to a circular outer edge (60) of the intermediate annular flat section 56, and a circular inner edge 61 of the intermediate annular flat section 56 is joined to a circular outer edge (61) of the central circular projected section 58. These sections as a whole form a disk with unevenness. That is, the intermediate annular flat section 56 forms a recessed section between the peripheral annular projected section 57 and the central circular projected section 58 relatively to these sections. Here, “projected” indicates that a section is projected forward toward the sound communication hole 40 in the microphone 10. Note that, although the intermediate annular flat section 56 is described as being placed on the plane S that is identical with the peripheral annular flat section 55 in this example, the intermediate annular flat section 56 may be placed in a position deviated forward or to the base side (backward) with respect to the peripheral annular flat section 55. Moreover, the intermediate annular flat section 56 to be relatively a recessed section may be curved concavely instead of being flat. In addition, although the edges 59, 60 and 61 are shown as squared in the illustrated example, typically, they are rather curved smoothly more or less. However, at least one or all of the edges 59, 60 and 61 maybe squared.

The waterproof sheet 50 is held between the cover side housing section 13 and the base side housing section 12 in a state in which it is pressed by the packing 44 to be pushed against the front end surface 36 of the cylindrical section 25 of the front side ring-like frame section 30 in the external peripheral part 52 of the peripheral annular flat section 55. As a result, a front side air chamber 47 is formed between an inner recessed section 46 around the sound communication hole 40 of the cover side housing section 13 and the front surface 51 of the waterproof sheet 50, and an inner air chamber 63 (a front space section for the microphone main body 17) is formed between an inner surface 62 of the waterproof sheet 50 and the recessed sections 33 and 35. The front side air chamber 47 is opened only in the sound communication hole 40, and the inner air chamber 63 is sealed substantially water-tightly by the packings 43 and 44.

The inner air chamber 63 and the opening 29 have sufficient volumes and areas, respectively, such that vibration of the inside air, which is associated with vibration of the waterproof sheet 50 at the time of normal use of the microphone 10, can be transmitted to the electroacoustic transducing element 19 of the microphone main body 17 at an audible frequency in a wide area with minimum attenuation. For example, in the case in which the film thickness of the waterproof sheet 50 consisting of PET or polyimide was 12 μm, it was confirmed experimentally that a volume of the inner air chamber 63 is preferably approximately 120 mm³ or more and a cross section of the opening 29 is preferably approximately 50 mm² or more (however, when a length (depth) of the opening 29 is approximately 0.3 mm and the cover 21 consisting of a porous metal plate with a thickness of approximately 0.1 mm, which is provided with a large number of holes with a diameter of approximately 0.5 to 1 mm, is arranged on the front surface of the microphone main body 17). Note that, in this case, a radius and a length of the inner peripheral surface 31 of the recessed section 33 were approximately 8 mm and approximately 0.3 mm, respectively, and a radius and a length of the opening 29 were approximately 4 mm and approximately 0.3 mm, respectively.

When an acoustic signal such as a voice enters the front side air chamber 47 from the sound communication hole 40 in the form of air vibration, that is, a compressional wave of the air, the waterproof sheet 50 forming the bottom of the front side air chamber 47 is vibrated in response to the air vibration to vibrate the air in the inner air chamber 63. The air vibration in the inner air chamber 63 is transmitted to the electroacoustic transducing element 19 of the microphone main body 17 via the holes 23 and taken out as an electric signal. Note that, in the waterproof sheet 50, since the film surface of the waterproof sheet 50 is irregular projecting outward D1 and inward D2, the waterproof sheet 50 can be vibrated simply by bending the film surface such that a state of curving of the unevenness varies. Thus, the waterproof sheet 50 is easily vibrated by an extremely small external force compared with the case in which the film surface of the waterproof sheet 50 is extended. As a result, a resistance or an energy loss with respect to the transmission of the air vibration from the front side air chamber 47 to the inner air chamber 63 can be controlled to the minimum. Therefore, it is less likely that a sensitivity of the microphone 10 provided with the waterproof sheet 50 and the microphone main body 17 is degraded.

On the other hand, in the case in which a relatively high water pressure is applied or a pressure is suddenly applied to the waterproof sheet 50 by pouring tap water on the arm-wear-type cellular phone 1, exposing it to rain or the like, or dropping it into water by mistake when it is worn around the arm, the waterproof sheet 50 deforms inward D2 to the inner air chamber 63 as indicated by an imaginary line 50i in FIG. 2. Such a water pressure can be generated not only in the case in which water is filled in the front side air chamber 47 and a hydrostatic pressure is applied to the waterproof sheet 50 directly but also in the case in which, for example, the sound communication hole 40 is closed by water and the water is to further enter the front side air chamber 47, whereby an air pressure in the front side air chamber 47 rises. In the latter case, the water may enter the front side air chamber 47 only a little. In any case, in the deformation of the waterproof sheet 50 in the D2 direction, the peripheral annular projected section 57 and the central circular projected section 58 of the waterproof sheet 50 are spread. In this deformation for releasing the unevenness, the length of the waterproof sheet 50 along the extending direction of each film part (curved film surface) of the waterproof sheet 50 hardly changes practically. That is, the film itself constituting the waterproof sheet 50 is hardly extended practically. In addition, the waterproof sheet 50 with the irregularities extended (spread) is projected inward D1 to the surface 32 constituting the bottom of the inner air chamber 63 and the front surface 21a of the thin plate 21 and, when a pressure of the front side chamber 47 is high, abuts the surfaces 31 and 21a to rest against them. As described above, such a deformation of the waterproof sheet 50 is realized by flexibility of the film of the waterproof sheet 50 only without extending the film forming the waterproof sheet 50 practically. On the other hand, in accordance with the projected deformation to the inner air chamber 63 side of the waterproof sheet 50, the volume of the inner air chamber 63 decreases and the air pressure in the inner air chamber 63 rises to realize a state in which the air pressure substantially balances with the outside water pressure. As a result, the film itself of the waterproof sheet 50 hardly supports a pressure difference practically to take a bent state as indicated by the imaginary line 50i. In this bent state, since the film of the waterproof sheet 50 is hardly extended, when the water pressure applied to the inside of the front side air chamber 47 is released, the water in the front side air chamber 47 is discharged from the sound communication hole 40 and, at the same time, the film of the waterproof sheet 50 returns to the state indicated by the solid line in FIG. 2 by an elastic force thereof.

Note that a plurality of sound communication holes 40 may be formed instead of one. In this case, if water enters the front side air chamber 47, the water is easily discharged. In addition, the waterproof sheet 50 may be adapted to support a pressure difference of a certain degree (e.g., approximately 1,000 hPa (one atm.) without being extended over an elastic limit practically.

Note that, for example, the corner parts of the bottom surface 32 and the peripheral surface 34 may have roundness such that the waterproof sheet 50 is easily curved along the wall surfaces of the recessed sections 33 and 35 when it rests against the wall surfaces. The same is applied to the corner parts of the front end surface 36 and the inner peripheral surface 31. In addition, the bottom surface 32 itself may incline so as to be deeper as it is closer to the center C, and the peripheral surface 34 may incline so as to be closer to the center C as it becomes deeper.

In addition, as described above, even in the case in which a water pressure or the like is applied to the housing 11, if the water pressure is up to, for example, approximately 3,000 hPa (3 atms.), the packings 44 and 43 can prevent water from entering the recessed section 15 of the base side housing section 12 reliably. Thus, it is practically unlikely that the water penetrates the microphone main body 17. As a result, an acoustic characteristic of the microphone 10 provided with the waterproof sheet 50 can keep its original state in conjunction with the ability of the waterproof sheet 50 to return to its original state without being extended. Note that the packings 43 and 44 inhibit acoustic signals other than a voice entering from the sound communication hole 40 from entering the electroacoustic transducing element 19 of the front surface 20 of the microphone main body 17 and, at the same time, inhibit a voice entering from the sound communication hole 40 from entering the electroacoustic transducing element 19 of the microphone main body 17 without passing through the inner air chamber 63. Therefore, since there is no invasion of a voice, it is less likely that the acoustic characteristic of the microphone 10 is degraded.

Although there is only one annular projected section of the waterproof sheet 50 (the peripheral annular projected section 57) in the illustrated example, it may be formed in a plural form. In addition, the dome-like central projected section 58 is preferably projected toward the entire surface as in the illustrated example. However, it may be a recessed section projected toward the recessed section 33 side. Moreover, there may be no projected section in the center including the central axis line C and a central side annular projected section may be formed around the center. In this case, only one annular projected section may be formed in the waterproof sheet 50 as a whole.

What is claimed is:

1. A waterproof electroacoustic transducer comprising:
an electroacoustic transducer main body provided with an electroacoustic transducing element on a front surface thereof;
a frame body forming a recessed section with the electroacoustic transducing element of the electroacoustic transducer main body as a bottom wall thereof; and
a waterproof sheet with flexibility that is fixed to the frame body in a peripheral part thereof so as to close a front opening of the recessed section in order to turn the recessed section into a closed air chamber and follows acoustic vibration of the air inside and outside the air chamber,
wherein the waterproof sheet is provided with a projected section curved forward convexly with respect to an average extending direction thereof in a state in which no external force is applied to the waterproof sheet such that the waterproof sheet can bend toward the inside of the recessed section while maintaining a length along an extending direction of the waterproof sheet under pressurization.

2. A waterproof electroacoustic transducer according to claim 1, wherein the waterproof sheet is provided with irregularities projected or recessed forward or rearward with respect to an average extending direction thereof in a state in which no external force is applied to the waterproof sheet such that the waterproof sheet can bend along a wall part of the recessed section while maintaining a length along an extending direction of the waterproof sheet under pressurization.

3. A waterproof electroacoustic transducer according to claim 2, wherein respective edges of the irregularities of the waterproof sheet extend in the form of a closed curve along the peripheral wall of the recessed section.

4. A waterproof electroacoustic transducer according to claim 2, wherein the waterproof sheet is provided with a projected section extending in a closed curve shape in the vicinity of a fixed peripheral part thereof as the irregularities.

5. A waterproof electroacoustic transducer according to claim 2, wherein the waterproof sheet is provided with a dome-like section projected forward convexly in the central part thereof as the irregularities.

6. A waterproof electroacoustic transducer according to claim 2, wherein the waterproof sheet is a film made of resin.

7. A waterproof electroacoustic transducer according to claim 1, wherein the waterproof sheet is thicker than approximately 10 μm or is thinner than approximately 30 μm.

8. A waterproof electroacoustic transducer according to claim 1, wherein the frame body is provided with a central opening section communicating with the electroacoustic transducing element of the electroacoustic transducer main body and a ring-like recessed section of a larger diameter placed on the front surface of the central opening section, and supports the peripheral part of the waterproof sheet in an end surface of a peripheral wall of the recessed section.

9. A waterproof electroacoustic transducer according to claim 1, wherein a porous metal plate is arranged on the front surface of the electroacoustic transducing element of the electroacoustic transducer main body.

10. A portable electronic device with a waterproof electroacoustic transducer, comprising:
the waterproof electroacoustic transducer according to claim 1; and
a cover side housing section provided with a sound communication hole opened in the front surface of a waterproof sheet,
wherein a part between the inside of the cover side housing section and the surface of the waterproof sheet is sealed water-tightly in a peripheral section of the waterproof sheet.

11. A portable electronic device with the waterproof electroacoustic transducer according to claim 10, further comprising a base side housing section provided with a transducer recieving recessed section for receiving the electroacoustic transducer,
wherein a part between the front surface of a peripheral wall of the transducer receiving recessed section of the base side housing section and the inside of the cover side housing section is sealed water-tightly.

12. A waterproof electroacoustic transducer according to claim 1, wherein the waterproof electroacoustic transducer comprises a microphone or a speaker.
